(19) United States
(12) Patent Application Publication
(10) Pub. No.: US 2015/0343310 A1
(43) Pub. Date: Dec. 3, 2015

(54) APPARATUS AND METHODS FOR COMPUTER IMPLEMENTED GAME

(71) Applicant: KING.COM LIMITED, St. Julians (MT)

(72) Inventor: Gabriel Constantin Cirlig, Bucharest (RO)

(21) Appl. No.: 14/288,789

(22) Filed: May 28, 2014

(51) Int. Cl. A63F 13/52

(52) U.S. Cl. CPC A63F 13/52

(57) ABSTRACT

A computer implemented game method, the method being implemented by at least one processor and at least one memory. The method comprises displaying a first game board arrangement having a plurality of game objects each having one or more characteristics, information on said game board arrangement and said game objects being stored in said at least one memory. The method also comprises determining a selection of a first game object in dependence on a user input received via a user interface and in dependence on the stored information on said game board arrangement. The method comprises executing an algorithm to determine if said user input is such that a pointer has been moved by at least a threshold distance and if so moving at least said game objects in dependence on said user input to provide an updated game board arrangement. The updated game board arrangement is displayed.

### FIELD OF THE INVENTION

Some embodiments may have particular, but not exclusive application in the field of computer implemented applications including for example games, in an online or offline environment, and computing devices therefor.

### BACKGROUND OF THE INVENTION

There are many technical challenges and technical considerations facing the designer of computer games executed on user or computer devices having a user interface, such as designing algorithms to enable a controllable user interface in the context of available computer devices and resources, which may be limited.

The translation of user interaction with an application, through the user interface, to meaningful application interaction provides a significant challenge in that algorithms are to be designed to translate such user interaction, through for example touch screen or other interface to actual interaction with the application being executed. A failure to do this reliably and in a manner that is evident to the user can lead to user disengagement with the product.

Such requirements are particularly challenging given the myriad or numerous and ever growing number of devices having varying hardware resources including input mechanisms that consumers wish to access such content on, particularly when considering a world-wide multi-national user base.

Further non-trivial problems also lie in the updating of the application and objects within the application displayed to a user, to ensure that the translation of user interaction through a user interface, to actual interaction with the application and the resulting evidence of that interaction should be transparent to the user, i.e. the latency between user interaction though a user interface and the interaction with the application becoming evident to the user, should be minimised.

### SUMMARY OF THE INVENTION

According to an aspect, there is provided a computer implemented game method, the method being implemented by at least one processor and at least one memory, said method comprising: displaying a first game board arrangement having a plurality of game objects each having one or more characteristics, information on said game board arrangement and said game objects being stored in said at least one memory; determining a selection of a first game object in dependence on a user input received via a user interface and in dependence on the stored information on said game board arrangement; and executing an algorithm to determine if said user input is such that a pointer has been moved by at least a threshold distance and if so moving at least said game objects in dependence on said user input to provide an updated game board arrangement; and displaying said updated game board arrangement.

The algorithm may be configured to determine if SQRT(dx*dx+dy*dy) is greater than said threshold distance where dx is the distance moved in an x direction and dy is a distance moved in a y direction.

The method may comprise determining which of a first component of movement of said pointer having a first direction or a second component of the pointer movement having a second direction has a greater magnitude, and if that magnitude exceeds said threshold, the first and second direction being orthogonal to one another.

The method may comprise determining a selection of a first set of game objects in dependence of the initial game object selection and pointer movement.

The first set of game objects may be in an x direction or a y direction.

The first set of game objects may comprise said selected first object.

The method may comprise updating said game board arrangement information such that the game objects of the first set are displayed at a first distance in the determined direction from the initial game board arrangement, the first distance dependent on pointer movement, and displaying said updated game board arrangement.

The algorithm may be is configured to determine if movement results in a valid game move.

If said movement does not result in a valid game move, said algorithm may be configured to return said game objects to first game board arrangement.

According to another aspect, there is provide an apparatus comprising at least one processor and at least one memory, said at least one processor and said at least one memory configured to perform at least one algorithm to provide a computer implemented game, said algorithm causing: a first game board arrangement to be displayed, said first game arrangement, having a plurality of game objects each having one or more characteristics, information on said game board arrangement and said game objects being stored in said at least one memory; a selection of a first game object to be determined in dependence on a user input received via a user interface and in dependence on the stored information on said game board arrangement; determining if said user input is such that a pointer has been moved by at least a threshold distance and if so moving at least one of said game objects in dependence on said user input to provide an updated game board arrangement; and displaying of said updated game board arrangement.

The algorithm may be configured to determine if SQRT(dx*dx+dy*dy) is greater than said threshold distance where dx is the distance moved in an x direction and dy is a distance moved in a y direction.

The algorithm may be configured to determine which of a first component of said pointer movement having a first direction or a second component of the pointer movement having a second direction has a greater magnitude, and if that magnitude exceeds a threshold, the first and second direction being orthogonal to one another.

The algorithm may be configured to determine a selection of a first set of game objects in dependence of the initial game object selection and pointer movement.

The first set of game objects may be in an x direction or a y direction.

The first set of game objects may comprise said selected first object.

The algorithm may be configured to update said game board arrangement information such that the game objects of the first set are displayed at a first distance in the determined direction from the initial game board arrangement, the first distance dependent on pointer movement, and displaying said updated game board arrangement.

The algorithm may be configured to determine if movement results in a valid game move.

If said movement does not result in a valid game move, said algorithm may be configured to return said game objects to first game board arrangement.

### BRIEF DESCRIPTION OF FIGURES

To understand some embodiments, reference will now be made by way of example only to the accompanying drawings, in which:

FIG. 1 shows an example embodiment of a game area or board;

FIG. 2 shows an example user device in which some embodiments may be provided;

FIG. 3 shows an example system in which some embodiments may be provided;

FIGS. 4A, 4B and 4C illustrate example selection mechanics according to some embodiments;

FIG. 5 illustrates an example object and action characteristics according to some embodiments;

FIG. 6 shows a method of an embodiment; and

FIGS. 7A and 7B show a game board of an embodiment.

### DETAILED DESCRIPTION OF THE INVENTION

Computer games, and in particular so-called “casual games”, which fit into the busy or hectic lifestyle of a consumer, are popular. It has been appreciated that there are many technical challenges and technical considerations for such a market, in particular in designing algorithms which engender user engagement (and thus repeat use or play) across a plethora of available user devices which have different hardware and may run differing operating systems. In particular, the inventors have realised that robust algorithms for detecting an analysing input reliably across such a spectrum of devices is required.

The techniques described herein can be implemented in for instance a computer application which involves the matching of objects displayed on a game area or game board and the elimination of such to complete a level or aim or target score of such a game. The game may be a so-called “casual” or “social” game, wherein short periods of play are undertaken by the user whenever appropriate according to the user's schedule.

Such games are increasingly offered and played by users on a wide range of devices such as portable devices such as smart pad or tables or larger devices such as desk top computers or lap top computers.

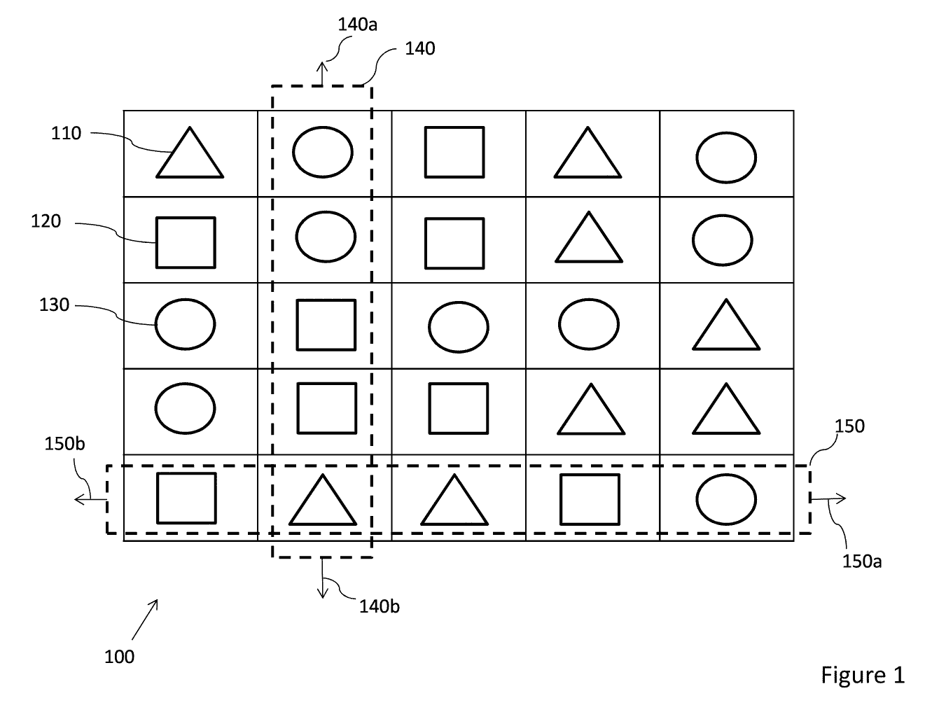

FIG. 1 shows an example schematic arrangement 100 for display on a user device according to an embodiment. An algorithm is configured to control the device such that an arrangement such as shown in FIG. 1 is displayed. The arrangement comprises a displayed game area 100 having first objects (also referred to as tiles or game elements) 110, 120, 130. Each tile has one or more attributes. Each attribute may have one or more possible values. These objects are game elements or tiles. The attributes may comprise color, shape, and/or different types of objects with associated value. The first objects may have other characteristics defining graphical representations and shapes, and may represent different types of similar objects when displayed on the game area 100.

First objects 110, 120, 130 may be removed from the game board 100 by user input sliding a row or column of first game objects 120 to create a sequence. The sequence may require three or more first game objects of having at least one attribute having the same value to be aligned adjacent one another in a row or column of said game area 100.

The game may, in one embodiment, end if the player or user runs out of time or moves before managing to reach a designated target such as a score or moves (not shown in FIG. 1).

Those skilled in the art will appreciate that the arrangement of other grid sizes or patterns may be suitable.

The first objects 110, 120, 130 displayed on the arrangement 100 may have four (or any other suitable number of) contact points with other neighbouring or adjacent first objects.

Other game board layouts or configurations may be provided. For example, pyramidal, hexagonal, octagonal or other layouts comprising position spaces or tiles within the game board 100 may be provided for display.

The number of differing colours may for example be three or more colours.

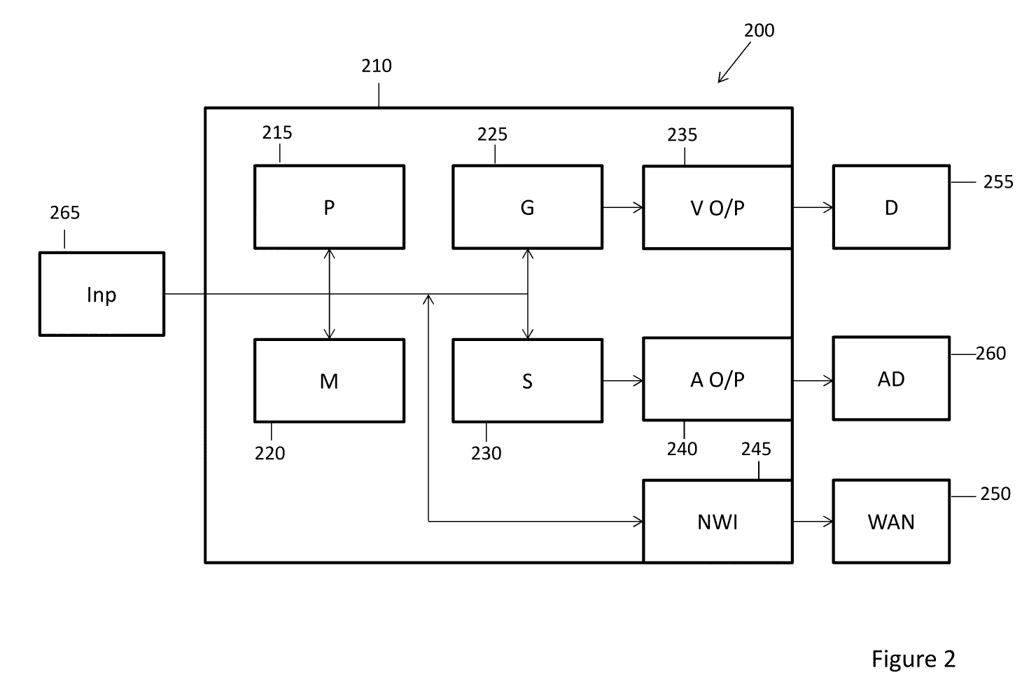

A schematic view of a user or computing device 200 according to an embodiment is shown in FIG. 2. All of the blocks shown are implemented by suitable circuitry and/or may be software modules. The blocks may be implemented in hardware and/or software. The user device may have a control part 210. The control part 210 has one or more processors 215 and one or more memories 220. The control part 210 is also shown as having a graphics controller 225 and a sound controller 230. It should be appreciated that one or other or both of the graphics controller 225 and sound controller 230 may be provided by the one or more processors 215.

The graphics controller 225 is configured to provide a video output 235. The sound controller 230 is configured to provide an audio output 240. The controller 210 has an interface 245 allowing the device to be able to communicate with a network 250 such as the Internet or other communication infrastructure.

The video output 235 is provided to a display 255. The audio output 240 is provided to an audio device 260 such as a speaker and/or earphone(s).

The device 200 has an input device 265. The input device 265 can take any suitable format and can be one or more of a keyboard, mouse, touch screen, joystick or game controller. It should be appreciated that the display 255 may in some embodiments also provide the input device 265 by way of an integrated touch screen for example.

The blocks of the controller 210 are configured to communicate with each other by an interconnect such as a bus or any other suitable interconnect and/or by point to point communication.

It should be appreciated that in some embodiments, the controller 210 may be implemented by one or more integrated circuits, at least in part.

The user device 200 is shown by way of example only. In alternative embodiments, one or more of the parts may be omitted. Alternatively or additionally, some embodiments may comprise one or more other parts. Alternatively or additionally, one or more parts may be combined.

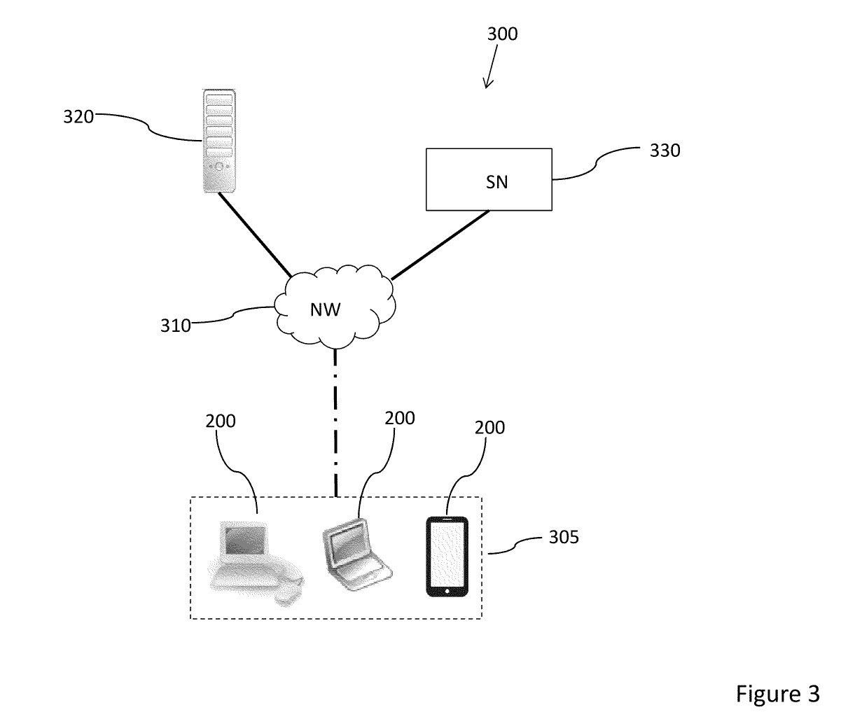

FIG. 3 schematically shows a system 300 in some embodiments. The system 300 comprises a server 320 which may store databases of game players' details, profiles, high scores and so on. In practice, one or more databases may be provided. Where more than one server is provided, the database(s) may be provided in one database or across two or more servers 320. The server 320 may also have a games data function. This may comprise a memory to store the computer game program and a processor to run the games program.

The server may communicate via for instance the internet 310 to one or more user devices 305 and may further provide connections to a social network 330 such as facebook™.

It should be appreciated that embodiments may be deployed in different system architectures. For example, the computer game may be implemented as a computer game that is stored in the memory 220 of the user device 200 and is run on the processor 215 of the user device 200. However, the server 320 may handle some elements of the game in some embodiments. By way of example only, a Java game applet may be provided to the user device 200 and the locally running Java applet will generate, for example, the graphics, sounds, and user interaction for the game play on the user device 200. Some data may be fed back to the server 320 to allow interaction with other players 305. The data which is fed back may also allow scoring and/or cross platform synchronization.

In some embodiments, the game may be implemented as a computer program that is stored in a memory of the system, for example the server 320, and which runs on a processor of the game server. Data streams or updates are supplied to the user device 200 to allow the user device 200 to render and display graphics and sounds in a browser of the user device 200. Such an approach is sometimes referred to as a web services approach. It should be appreciated, however, that such an approach does not necessarily require the use of the Internet.

It should be appreciated that some embodiments may be provided as stand-alone games on the user device.

The device and systems of FIGS. 2 and 3 may execute various algorithms as will be described.

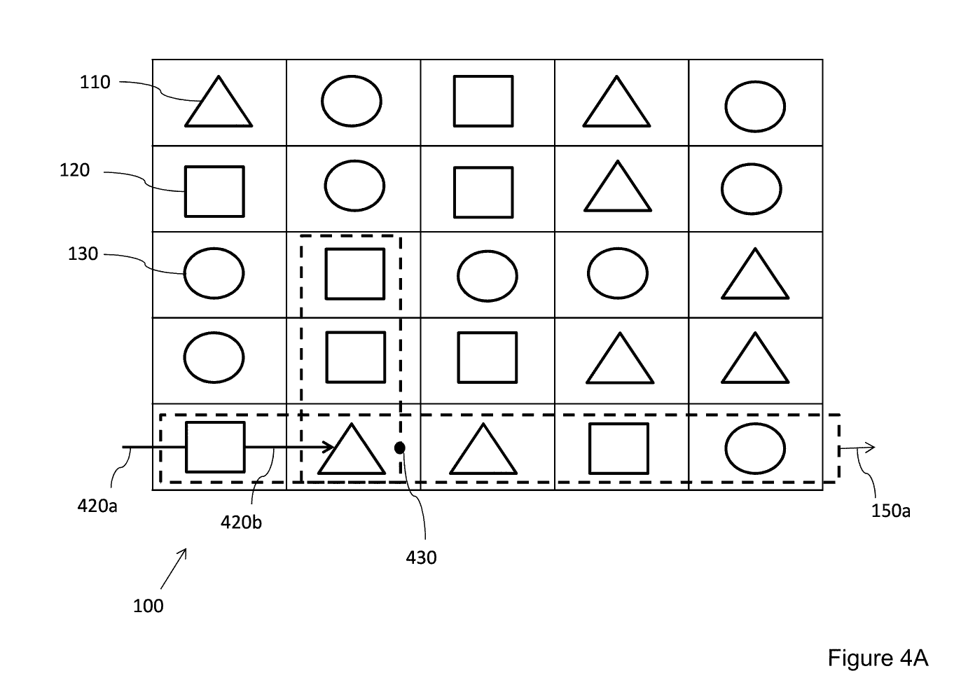

FIG. 4A shows the game area and arrangement of FIG. 1. Input via the user input is detected at a position corresponding to object 420a to select the object 420a. The selection of the object may be by the user moving a cursor using a pointer device such as a mouse, a touch pad or the like. Alternatively the selection of the object may be detected by detecting a user's finger or the like at a location of a touchscreen at the position of the displayed object.

A subsequent slide input is detected indicating that the user wishes to slide the row in which object 420a is located in the direction of arrow 420b as shown. In doing so, a rearrangement algorithm may be invoked by processor 215 if the movement creates a matching sequence of three or more first objects as shown by region 430 and the end of input is detected.

FIG. 4B illustrates the region 430 creating a match since at least three objects 120 and 420a sharing at least one same characteristic are aligned adjacent each other after the input.

A match may comprise three or more objects sharing at least one same characteristic being repositioned to be adjacent each other in a column if the input movement is in a horizontal direction with respect to the arrangement 100 or the three or more objects may be adjacent each other in a row if the input movement is in a vertical direction with respect to the arrangement 100.

Such a detected match causes the processor 215 to execute a rearrangement and update object algorithm. This is shown pictorially on the right side of FIG. 4B wherein objects 120 of selected match area 430 have been replaced by objects 130, 110. In particular object 420a has been upgraded to object 440 having at least one different characteristic to the previously matched first object characteristics, whilst still sharing at least one same characteristic.

FIG. 4B indicates this by way of example by depicting object 440 as a larger square shaped object 440 with an indication (here simply shown as crosshatching) that the object has been upgraded from a first level to second.

FIG. 4C indicates a further level upgrade following a subsequent match of three adjacent objects including object 440, wherein already updated object 440 been replaced by a further upgraded object 450 as indicated in the figure.

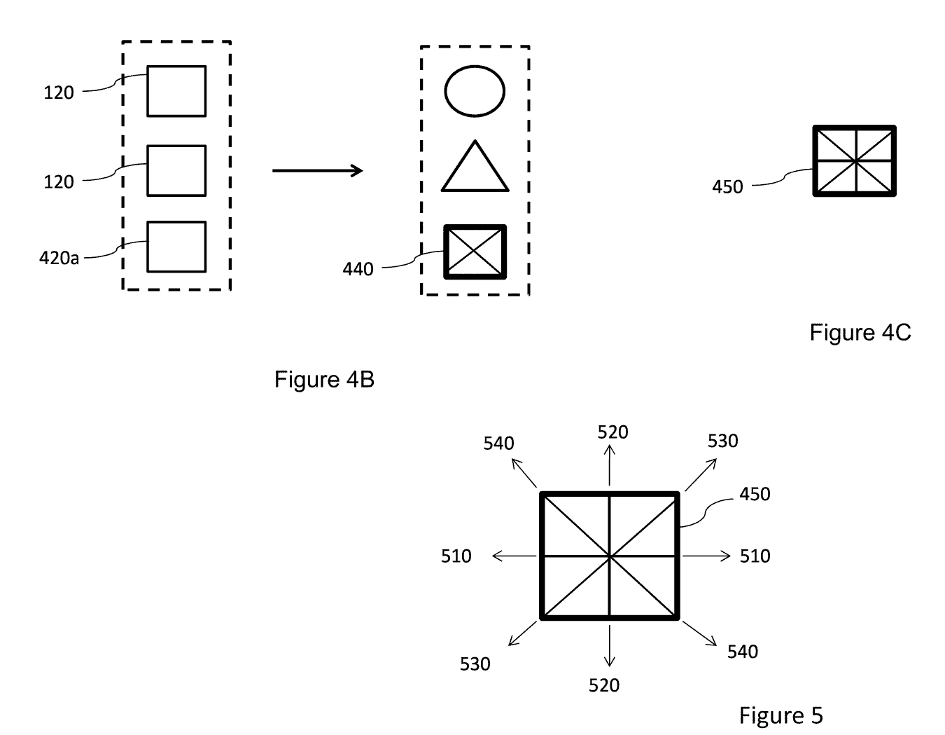

FIG. 5 illustrates pictorially object 450 after upgrade with an indication of at least one associated action characteristic 510, 520, 530, 540. For example, selection of the further upgraded object 450 in a subsequent match may activate one or more of the action characteristics of the object 450 to remove and replace all objects along a row 510, column 520 or those occupying positions that are in diagonal 530, 540 from the position of the activated object 450.

In some embodiments, the number of different upgrade levels available may be two or more. In some games, the number of upgrade levels may be three. When the object has been upgraded the maximum number of times, the upgraded object, when in a match will provide an action which removes tiles in addition to the tiles being match. For example, the action may be line blasters or bomb type effects.

The action provided may be selected at random. In some embodiments, only one type of action is provided in a game. In some embodiments, the action provided may be associated with a value of an attribute of the object. The value of the attribute may the same attribute which is used when matching. The attribute may be colour or any other suitable attribute.

Other action characteristics may be provided in memory 220, and may be selected randomly to apply to an upgraded object.

Other action characteristics may comprise increasing the score or value associated with the object 440, 450, activating special or other objects within the game area 100, or acting as a localised bomb by destroying all adjacent objects surrounding the activated further upgraded object 450.

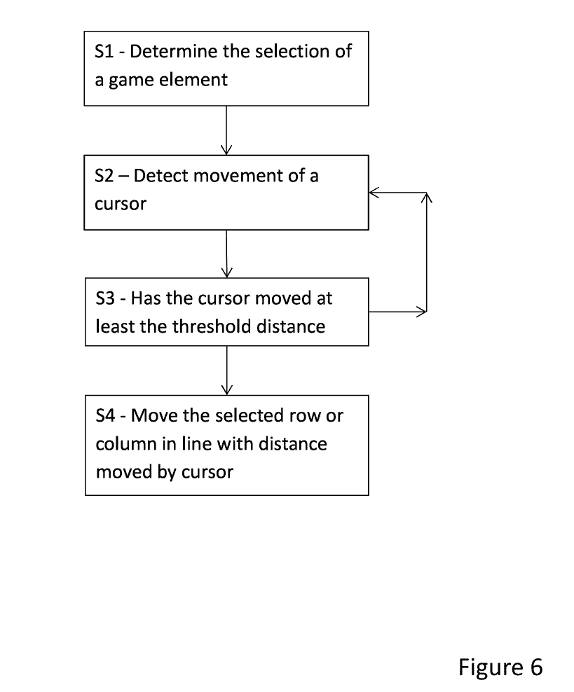

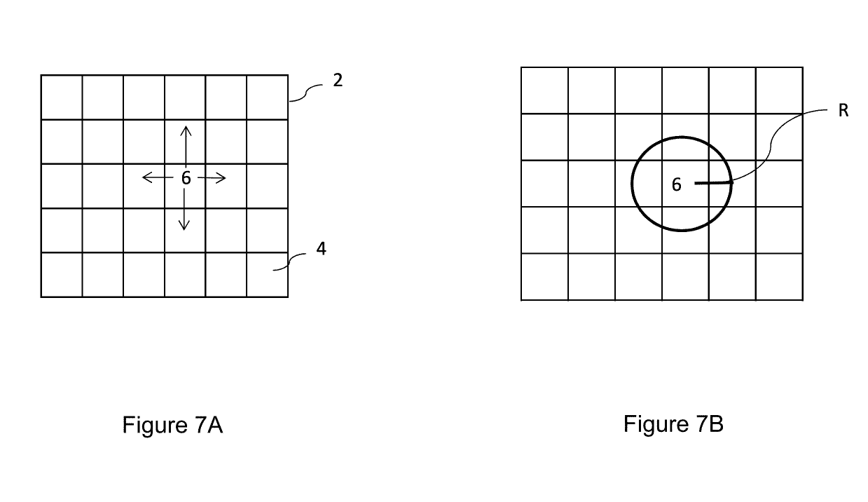

Reference is made to FIG. 6 in conjunction with FIGS. 7A and 7B. FIG. 7a schematically shows a game board 2 which has a plurality of tiles 4 arranged in rows and columns, such as previously described.

In step S1, a determination is made by the algorithm that a game element has been selected. This is game element 6 of FIG. 7a. It should be appreciated that any suitable technique may be used to determine that a game element has been selected including determining which game element has been selected. In some embodiments the row or column of the selected game element is to be moved respectively horizontally or vertically as shown by the arrows in FIG. 7A.

In step S2, a determination is made by the algorithm that a cursor or other pointer controlled by the user is moving relative to the game board.

However, in some embodiments, no selection or change is made to the game board until the cursor or pointer has moved at least a threshold distance. Accordingly in step S3, the algorithm will check if the cursor has been moved by at least a threshold distance.

If not, the algorithm loops back to step S2. If yes, the next step is step S4 and the algorithm will cause the selected row or column to move in line with the distance moved by the pointer.

In some embodiments, the algorithm will determine if a valid move is being made by the user before moving any tiles. For example, in the context of a slider game, such as previously discussed, the algorithm will determine if the input has selected a row or a column and only move the tiles if a respective row or column has been selected.

In some embodiments the algorithm checks for a certain threshold which is computed based on the dx and dy distances. The dx distance is the distance the user has dragged the mouse since he clicked to select the initial tile in the x direction with dy being the corresponding distance in the y direction. In some embodiments, the following determination is made:

Threshold SQRT(dx*dx+dy*dy)

Only if the value computed is greater than or equal to the threshold is the cursor moved. The SQRT(dx*dx+dy*dy) represents the distance moved. The threshold defines a circle of radius R around a central point of a selected game tile, as shown in FIG. 7B.

Thus, after the initial game object has been selected, the algorithm will check to see if the user has moved the cursor using the pointing device or the like at least a threshold distance. Only if the user has moved the cursor by at least the threshold distance R will the row or column be selected and moved in a direction in accordance with the user input. In some embodiments, the cursor or the like has to be moved by at least the threshold distance whilst in other embodiments, the cursor or the like has to be moved by a distance greater than the threshold distance.

In some embodiments, the threshold may be selected in dependence on the size of screen used to play the game.

In some embodiments, the threshold may be selected in dependence on the resolution of the screen.

In some embodiments, the threshold may be selected to be less than the size of a tile.

In some embodiments, the threshold may be of the order of 20 pixels.

It should be appreciated that some embodiments may be used in different games to those described. Some embodiments may be used with games where a plurality of game elements are arranged to provide a game board.

In some embodiments, the algorithm may alternatively or additionally determining which of a first component of said pointer movement having a first direction or a second component of the pointer movement having a second direction has a greater magnitude, and if that magnitude exceeds a threshold, the first and second direction being orthogonal to one another. The first and second direction may be x and y directions. This may be used in some embodiments to determine a direction of movement for the selected game object, that is if the row or column is selected.

In some embodiments, the algorithm may determine a selection of a first set of game objects in dependence of the initial game object selection and pointer movement. The first set of game objects may be in a row or in a column. It should be appreciated that the first set of game objects comprises said selected game object.

In some embodiments, the algorithm may be arranged to update the game board arrangement information such that the game objects of the first set are displayed at a first distance in the determined direction from the initial game board arrangement, the first distance dependent on pointer movement, and to cause the displaying of the updated game board arrangement.

In some embodiments, the algorithm is configured to determine if movement results in a valid game move. This would be if the movement of the row or column results in at least three game objects matching, in the context of the above described game. If the movement does result in a valid game move, then the movement is permitted. If the movement does not result in a valid game move, the algorithm is configured to return said game objects to first game board arrangement. For example when the pointer is released via the user input, the game objects move back to the original positions.

In some embodiments, the algorithm may be configured to detect a speed of user input. Speed of change of display may depend on the speed of user input.

Some embodiments may be used with a mouse or the like which controls the position of a pointer. The pointer may be a cursor. It should be appreciated that other embodiments may use a touch pad or a touch screen to control the position of the pointer.

Some embodiments have been described by way of example with respect to example games. It should be appreciated, that other embodiments may be provided in the context of any other suitable games.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

It is also noted herein that while the above describes embodiments of the invention, there are several variations and modifications which may be made to the disclosed solution without departing from the scope of the present invention.

1. A computer implemented game method, the method being implemented by at least one processor and at least one memory, said method comprising:
displaying a first game board arrangement having a plurality of game objects each having one or more characteristics, information on said game board arrangement and said game objects being stored in said at least one memory,
determining a selection of a first game object in dependence on a user input received via a user interface and in dependence on the stored information on said game board arrangement, and
executing an algorithm to determine if said user input is such that a pointer has been moved by at least a threshold distance and if so moving at least one game objects in dependence on said user input to provide an updated game board arrangement; and
displaying said updated game board arrangement.

2. A method as claimed in claim 1, wherein said algorithm is configured to determine if SQRT(dx*dx+dy*dy) is greater than said threshold distance where dx is the distance moved in an x direction and dy is a distance moved in a y direction.

3. A method as claimed in claim 1, comprising determining which of a first component of said pointer movement having a first direction or a second component of the pointer movement having a second direction has a greater magnitude, and if that magnitude exceeds a threshold, the first and second direction being orthogonal to one another.

4. A method as claimed 1, determining a selection of a first set of game objects in dependence of the initial game object selection and pointer movement.

5. A method as claimed in claim 4, wherein said first set of game objects is in an x direction or a y direction.

6. A method as claimed in claim 4, wherein said first set of game objects comprises said selected first object.

7. A method as claimed in claim 1, comprising updating said game board arrangement information such that the game objects of the first set are displayed at a first distance in the determined direction from the initial game board arrangement, the first distance dependent on pointer movement, and displaying said updated game board arrangement.

8. A method as claimed in claim 1, wherein said algorithm is configured to determine if movement results in a valid game move.

9. A method as claimed in claim 8, wherein if said movement does not result in a valid game move, said algorithm is configured to return said game objects to first game board arrangement.

10. An apparatus comprising at least one processor and at least one memory, said at least one processor and said at least one memory configured to perform at least one algorithm to provide a computer implemented game, said algorithm causing:
a first game board arrangement to be displayed, said first game arrangement, having a plurality of game objects each having one or more characteristics, information on said game board arrangement and said game objects being stored in said at least one memory,
a selection of a first game object to be determined in dependence on a user input received via a user interface and in dependence on the stored information on said game board arrangement,
determining if said user input is such that a pointer has been moved by at least a threshold distance and if so moving at least one of said game objects in dependence on said user input to provide an updated game board arrangement; and
displaying of said updated game board arrangement.

11. An apparatus as claimed in claim 10, wherein said algorithm is configured to determine if SQRT(dx*dx+dy*dy) is greater than said threshold distance where dx is the distance moved in an x direction and dy is a distance moved in a y direction.

12. An apparatus as claimed in claim 1, wherein said algorithm is configured to determine which of a first component of said pointer movement having a first direction or a second component of the pointer movement having a second direction has a greater magnitude, and if that magnitude exceeds a threshold, the first and second direction being orthogonal to one another.

13. An apparatus as claimed 10, wherein said algorithm is configured to determine a selection of a first set of game objects in dependence of the initial game object selection and pointer movement.

14. An apparatus as claimed in claim 13, wherein said first set of game objects is in an x direction or a y direction.

15. An apparatus as claimed in claim 13, wherein said first set of game objects comprises said selected first object.

16. An apparatus as claimed in claim 10, wherein said algorithm is configured to update said game board arrangement information such that the game objects of the first set are displayed at a first distance in the determined direction from the initial game board arrangement, the first distance dependent on pointer movement, and displaying said updated game board arrangement.

17. An apparatus as claimed in claim 10, wherein said algorithm is configured to determine if movement results in a valid game move.

18. An apparatus as claimed in claim 17, wherein if said movement does not result in a valid game move, said algorithm is configured to return said game objects to first game board arrangement.
